(19) United States
(12) Patent Application Publication
(10) Pub. No.: US 2026/0343485 A1
(43) Pub. Date: Oct. 29, 2026

(54) WIRELESS COMMUNICATION DEVICE AND METHOD FOR CONTROLLING WIRELESS COMMUNICATION DEVICE

(71) Applicant: SONY SEMICONDUCTOR SOLUTIONS CORPORATION, KANAGAWA (JP)

(72) Inventors: Katsuyuki TANAKA, KANAGAWA (JP); Takuya OKAMOTO, KANAGAWA (JP)

(21) Appl. No.: 19/110,830

(22) PCT Filed: Jul. 28, 2023
(86) PCT No.: PCT/JP2023/027701

§ 371 Date: Mar. 12, 2025

(30) Foreign Application Priority Data
Sep. 22, 2022 (JP) 2022-151053

(51) Int. Cl. H04W 64/00

(52) U.S. Cl. CPC H04W 64/006

(57) ABSTRACT

To improve versatility and convenience in a wireless communication device that performs positioning on the basis of signals received by a plurality of antennas. A first transmission antenna transmits a first transmission signal including one of a request related to a positioning method and a response to the request. A first reception antenna receives a first satellite signal. A second reception antenna receives a first reception signal including either the other of the request and the response or the beacon signal. A selector selects one of the first satellite signal and the first reception signal and supplies the selected signal as a selection signal. A first orthogonal detection unit performs orthogonal detection on the selection signal. A processing unit measures the current position on the basis of either the first satellite signal or the beacon signal.

### TECHNICAL FIELD

The present technology relates to a wireless communication device. Specifically, the present invention relates to a wireless communication device that measures a current position and a method for controlling the wireless communication device.

### BACKGROUND ART

In recent years, with the spread of Internet of Things (IOT) technology, the importance of position information has been increasing year by year in its use. Conventionally, a global navigation satellite system (GNSS) receiver has existed as a positioning infrastructure outdoors. Furthermore, even indoors, a positioning method/means using a radio band such as wireless fidelity (WiFi), Bluetooth low energy (BLE), or ultra wide band (UWB) or a sensor is used even if it is not established as much as GNSS. Specifically, examples thereof include Round Trip Time, Angle of Departure (AoD), and Angle of Arrival (AoA). Although the positioning means is different between outdoors and indoors, it is desirable that the behavior of a person or the like is seamless indoors and outdoors, and the position information can also be acquired seamlessly. Therefore, in recent years, there have been increasing positioning terminals in which a plurality of wireless positioning means is individually mounted to perform seamless positioning indoors and outdoors, a GNSS signal is received and positioning is performed mainly outdoors, and a signal from a locator such as Wi-Fi or BLE is received and positioning is performed indoors.

For example, a reception device provided with a frequency conversion unit that receives a satellite signal from a GNSS satellite and a beacon signal on the Wi-Fi standard in a time division manner, and a positioning calculation storage unit that measures a current position from the satellite signal or the beacon signal has been proposed (see, for example, Patent Document 1). In this reception device, a path for receiving a satellite signal and a path for receiving a beacon signal share a circuit after the mixer in the frequency conversion unit.

### CITATION LIST

### Patent Document

Patent Document 1: U.S. Pat. No. 10,295,676

### SUMMARY OF THE INVENTION

### Problems to be Solved by the Invention

In the above-described conventional technique, the circuit in the frequency conversion unit is shared by the two reception paths, thereby reducing the cost and the mounting area. However, in the reception device described above, various positioning methods such as the AoA method and the AoD method used indoors cannot be used, and versatility and convenience may be insufficient.

The present technology has been made in view of such a situation, and an object thereof is to improve versatility and convenience in a wireless communication device that performs positioning on the basis of signals received by a plurality of antennas.

### Solutions to Problems

The present technology has been made to solve the above-described problems, and a first aspect thereof is a wireless communication device and a control method thereof, the wireless communication device including: a first transmission antenna that transmits a first transmission signal including one of a request related to a positioning method and a response to the request; a first reception antenna that receives a first satellite signal; a second reception antenna that receives a first reception signal including either another of the request and the response or a beacon signal; a selector that selects one of the first satellite signal and the first reception signal and supplies the selected signal as a selection signal; a first orthogonal detection unit that performs orthogonal detection on the selection signal; and a processing unit that measures a current position on the basis of either the first satellite signal or the beacon signal. Therefore, this configuration provides an effect of improving wiring efficiency.

Furthermore, in the first aspect, both the first transmission signal and the first reception signal may be signals conforming to the Bluetooth standard. Therefore, this brings about an effect that the current position is measured from a signal conforming to the Bluetooth standard.

Furthermore, in the first aspect, the positioning method may include at least one of an angle of arrival (AoA) method and an angle of departure (AoD) method. Therefore, this brings about an effect that the current position is measured from the arrival angle and the radiation angle.

Furthermore, in the first aspect, the wireless communication device further includes: a first modulation unit that generates the first transmission signal. The processing unit may determine a positioning method on the basis of the response, stop the first modulation unit within a measurement period of a current position in a case where the AoD method is determined, and stop the first orthogonal detection unit within a measurement period of the current position in a case where the AoA method is determined. Therefore, this produces an effect that power consumption is reduced.

Furthermore, in the first aspect, the wireless communication device further includes: a third reception antenna that receives a second satellite signal having a different frequency band from the first satellite signal; and a second orthogonal detection unit that performs orthogonal detection on the second satellite signal. The processing unit may include: an outdoor positioning unit that measures a current position on the basis of at least one of the first and second satellite signals; and an indoor positioning unit that measures a current position on the basis of the first reception signal. Therefore, this brings about an effect that the second satellite signal and the first reception signal are simultaneously received.

Furthermore, in the first aspect, the wireless communication device further includes: a second transmission antenna that transmits a second transmission signal having a different communication standard from the first transmission signal; a fourth reception antenna that receives a second reception signal having a different communication standard from the first reception signal; and a second modulation unit that generates the second transmission signal. The selector may select one of the first satellite signal, the first reception signal, and the second reception signal. Therefore, this brings about an effect that communication based on a communication standard other than BLE is performed.

### BRIEF DESCRIPTION OF DRAWINGS

FIG. 1 is an example of an overall view of a communication system according to a first embodiment of the present technology.

FIG. 2 is a block diagram illustrating a configuration example of a wireless communication device according to the first embodiment of the present technology.

FIG. 3 is a block diagram illustrating a configuration example of a wireless communication device according to a comparative example.

FIG. 4 is a block diagram illustrating a configuration example of an orthogonal detection unit according to the first embodiment of the present technology.

FIG. 5 is a block diagram illustrating a configuration example of a digital front-end according to the first embodiment of the present technology.

FIG. 6 is a block diagram illustrating a configuration example of a processing unit according to the first embodiment of the present technology.

FIG. 7 is a diagram illustrating an example of control of a communication circuit according to the first embodiment of the present technology.

FIG. 8 is a diagram illustrating an example of a state of a communication circuit when a BLE positioning method is detected or authenticated according to the first embodiment of the present technology.

FIG. 9 is a diagram illustrating an example of a state of a communication circuit when positioning is performed using an AoD method according to the first embodiment of the present technology.

FIG. 10 is a diagram illustrating an example of a state of a communication circuit when positioning is performed using an AoA method according to the first embodiment of the present technology.

FIG. 11 is a flowchart illustrating an example of operation of the wireless communication device according to the first embodiment of the present technology.

FIG. 12 is a sequence diagram illustrating an example of operation of the communication system according to the first embodiment of the present technology.

FIG. 13 is a block diagram illustrating a configuration example of a wireless communication device according to a second embodiment of the present technology.

FIG. 14 is a block diagram illustrating a configuration example of a wireless communication device according to a third embodiment of the present technology.

FIG. 15 is a diagram illustrating an example of a schematic configuration of an IoT system to which the technology according to the present disclosure is applicable.

### MODE FOR CARRYING OUT THE INVENTION

A mode for carrying out the present technology (hereinafter, referred to as an embodiment) is hereinafter described. The description will be given in the following order.
1. First embodiment (example of transmitting and receiving request and response while sharing circuit)
2. Second embodiment (example of reducing reception path and transmitting and receiving request and response while sharing circuit)
3. Third embodiment (example of reducing transmission/reception path and transmitting request and response while sharing circuit)
4. Application examples

### 1. First Embodiment

### [Configuration Example of Communication System]

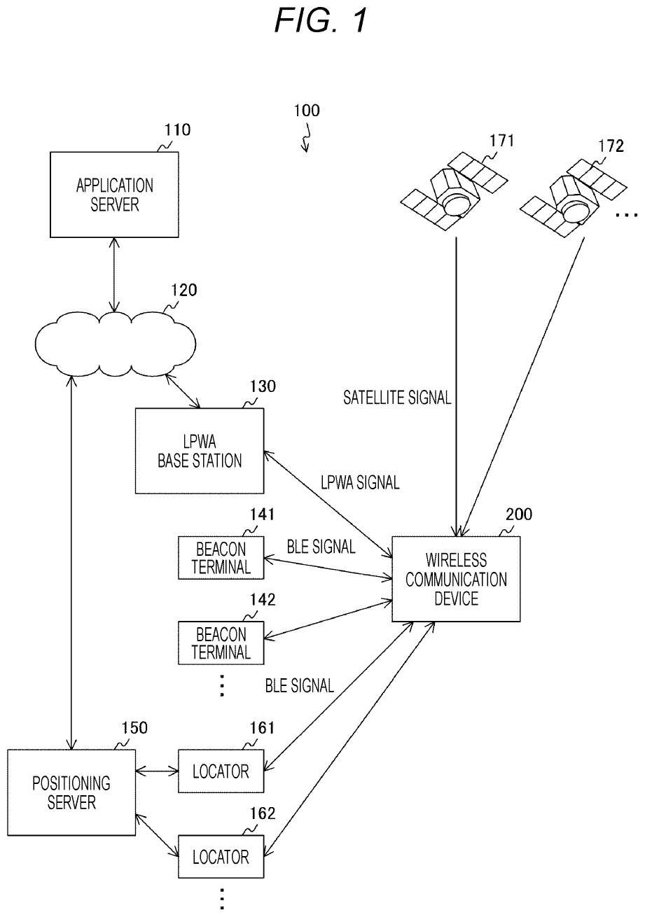

FIG. 1 is an example of an overall view of a communication system 100 according to a first embodiment of the present technology. The communication system 100 includes an application server 110, a low power wide area (LPWA) base station 130, a positioning server 150, and a wireless communication device 200. Furthermore, the communication system further includes a plurality of beacon terminals such as beacon terminals 141 and 142, a plurality of locators such as locators 161 and 162, and a plurality of GNSS satellites such as GNSS satellites 171 and 172.

The application server 110 communicates with the LPWA base station 130 and the positioning server 150 via a network 120 (the Internet or the like) and executes various applications. For example, an application for providing a service related to position information such as the wireless communication device 200 is executed.

The LPWA base station 130 transmits and receives an LPWA signal conforming to the LPWA communication standard to and from the wireless communication device 200. As the LPWA communication standard, for example, ELTRES (registered trademark) is used. Alternatively, LoRaWAN (Long Range Wide Area Network), Sigfox, LTE Cat.M1 (Long Term Evolution category M1), NB-IOT (Narrow Band-IoT), or the like is used. For example, the LPWA base station 130 receives LPWA signals including various data such as position information from a predetermined number of communication devices such as the wireless communication device 200, and transmits the data to the application server 110 via the network 120.

The beacon terminal 141 periodically transmits a beacon signal conforming to a predetermined communication standard. Furthermore, the beacon terminal 141 can transmit and receive a request regarding an available positioning method and a response to the request to and from the wireless communication device 200. It is assumed that, for example, BLE is used as a communication standard of the beacon terminal, and a radio signal (beacon signal, request, response, and the like) conforming to the BLE is hereinafter referred to as a “BLE signal”. The same applies to beacon terminals other than the beacon terminal 141.

The positioning server 150 measures the current position of the transmission source (such as the wireless communication device 200) on the basis of the BLE signal received by each of the plurality of locators. For example, the positioning server 150 obtains an arrival angle of a BLE signal received by each of the locators from a phase difference of the BLE signal, and measures a current position of the transmission source from the arrival angle and a known position of each of the locators. As described above, the positioning method for obtaining the current position from the arrival angle of the radio signal is called an AoA method. The positioning server 150 transmits position information indicating the current position to the application server 110 via the network 120.

The locator 161 has a function equivalent to that of a beacon terminal. Furthermore, the locator 161 can use the AoA method described above together with the positioning server 150. The same applies to locators other than the locator 161.

The GNSS satellite 171 periodically transmits a radio signal. hereinafter, this radio signal is referred to as a “satellite signal”. As the GNSS, for example, a global positioning system (GPS) is used. This GPS uses a plurality of frequency bands such as the L1 band and the L5 band. In general, the L1-band signal of the satellite signal is called an L1signal, and the L5-band signal is called an L5 signal. Note that the communication system 100 can also use a GNSS other than the GPS, such as Galileo, Beidou, or GLONASS. The same applies to GNSS satellites other than the GNSS satellite 171.

The wireless communication device 200 receives a satellite signal, and transmits and receives an LPWA signal and a BLE signal to and from the LPWA base station 130, a beacon terminal, and a locator. Furthermore, the wireless communication device 200 is a small device that can be carried and moved by a human. As the wireless communication device 200, for example, an IoT device is used. The wireless communication device 200 can be attached to an animal such as a dog or a cat in addition to a human. Furthermore, the wireless communication device 200 can also be mounted on a moving body such as a bicycle, an automobile, or a drone.

The wireless communication device 200 may move along with the movement of a person carrying the device, and the current position thereof may change. For this reason, the wireless communication device 200 may not be able to receive a satellite signal or a BLE signal depending on its current position. For example, it is easy to receive a satellite signal outdoors, but it is difficult to receive a satellite signal indoors. Furthermore, in a case where the beacon terminal or the locator is disposed indoors, it is easy to receive the BLE signal indoors, but it is difficult to receive the BLE signal outdoors. A positioning method suitable for indoor use, such as the AoA method or the AoD method using the BLE signal, is hereinafter referred to as an “indoor positioning” method.

Furthermore, the wireless communication device 200 can measure the current position on the basis of the satellite signal from each of the plurality of GNSS satellites. Since the positioning using the satellite signal is suitable for positioning in outdoor use, it is hereinafter referred to as “outdoor positioning”. Note that outdoor positioning is not necessarily performed outdoors, and may be performed indoors. Similarly, indoor positioning is not necessarily performed indoors, and may be performed outdoors.

Moreover, the wireless communication device 200 can measure the current position on the basis of BLE signals from a plurality of beacon terminals and locators. For example, the wireless communication device 200 receives a BLE signal including the position of the terminal or the like from a beacon terminal or a locator, and stores the respective positions. Then, the wireless communication device 200 obtains a radiation angle of each transmitted BLE signal of the beacon terminal or the like from the phase difference, and measures its own current position from the radiation angle and the position of the terminal or the like. In this manner, a positioning method for obtaining the current position from the radiation angle of the radio signal is called an AoD method.

Furthermore, the wireless communication device 200 can also use an indoor positioning method other than the AoD method. For example, the wireless communication device 200 obtains a received signal strength indicator (RSSI) of each transmitted BLE signal of a beacon terminal or the like. Then, the wireless communication device 200 estimates the distance to the transmission source on the basis of the RSSI, and measures its own current position by three-point measuring from the position of the beacon terminal or the like and the distance. Hereinafter, a positioning method for obtaining the current position from the RSSI is referred to as an “RSSI method”. Note that, in the RSSI method, the locator can obtain the RSSI instead of the wireless communication device 200, and the positioning server 150 can measure the current position.

Alternatively, the wireless communication device 200 can use an indoor positioning method other than the AoD method and the RSSI method. For example, the wireless communication device 200 transmits and receives signals to and from a plurality of beacon terminals and locators, obtains a round trip time of radio waves, and measures the current position from a distance corresponding to the round trip time and a position of the beacon terminal or the like. This method is called a channel sounding (CS) method or a high accuracy distance measurement (HADM) method.

In addition, the wireless communication device 200 can use various indoor positioning methods. For example, it is also possible to use a proximity method in which the position of the closest beacon terminal or the like is used as the current position as it is, or an environment analysis method in which a place most similar to a radio wave environment or a geomagnetic environment for each place investigated in advance is used as the current position. A positioning method obtained by combining the above-described positioning methods can also be used.

Note that the communication system 100 uses BLE when performing indoor positioning, but may use a communication standard (Wi-Fi or the like) other than BLE when performing indoor positioning.

In a case where there is a plurality of indoor positioning methods that can be used by the communication system 100, which indoor positioning method to use is appropriately determined by the wireless communication device 200 or an external device (such as the locator or the positioning server 150) of the device. For example, in a case where both the AoA method and the AoD method are available, the AoA method is preferentially used in order to reduce the load of the wireless communication device 200. Alternatively, the AoA method is used in a case where the remaining battery level of the wireless communication device 200 is less than a predetermined value or in the power saving mode, and the AOD method is used otherwise.

### [Configuration Example of Wireless Communication Device]

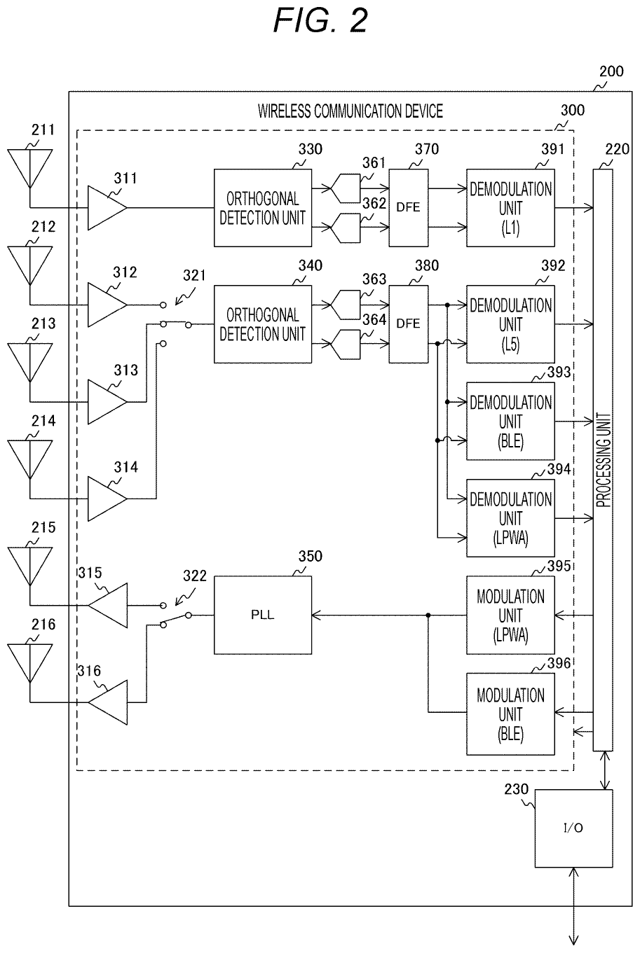

FIG. 2 is a block diagram illustrating a configuration example of the wireless communication device 200 according to the first embodiment of the present technology. The wireless communication device 200 includes reception antennas 211, 212, 213, and 214, transmission antennas 215 and 216, a communication circuit 300, a processing unit 220, and an input/output (I/O) interface 230. The communication circuit 300 includes low noise amplifiers 311, 312, 313, and 314, power amplifiers 315 and 316, selectors 321 and 322, orthogonal detection units 330 and 340, and a phase locked loop (PLL) 350. Moreover, the communication circuit 300 includes analog to digital converters (ADCs) 361, 362, 363, and 364, digital front-ends 370 and 380, demodulation units 391, 392, 393, and 394, and modulation units 395 and 396.

The reception antenna 211 receives one (for example, L1 signal) of the L1 signal and the L5 signal. The reception antenna 211 supplies the L1 signal to the low noise amplifier 311. Note that the L1 signal is an example of a second satellite signal described in the claims, and the reception antenna 211 is an example of a third reception antenna described in the claims.

The reception antenna 212 receives the other (for example, the L5 signal) of the L1 signal and the L5 signal. The reception antenna 212 supplies the L5 signal to the low noise amplifier 312. Note that the L5 signal is an example of a first satellite signal described in the claims, and the reception antenna 212 is an example of a first reception antenna described in the claims.

Note that the reception antenna 211 can receive the L5 signal, and the reception antenna 212 can receive the L1 signal. Furthermore, although two frequencies of the L1 band and the L5 band are received, it is also possible to receive two frequencies of another combination such as the L1 band and the L2 band. When the L1 band and the L2 band are received, the L2 signal is received by the reception antenna 312.

The reception antenna 213 receives a BLE signal. The BLE signal received by the reception antenna 213 is referred to as a BLE reception signal. The reception antenna 213 supplies the BLE reception signal to the low noise amplifier 313. Note that the BLE reception signal is an example of a first reception signal described in the claims, and the reception antenna 213 is an example of a second reception antenna described in the claims.

The reception antenna 214 receives an LPWA signal. The LPWA signal received by the reception antenna 214 is referred to as an LPWA reception signal. The reception antenna 214 supplies the LPWA reception signal to the low noise amplifier 314. Note that the LPWA reception signal is an example of a second reception signal described in the claims, and the reception antenna 214 is an example of a fourth reception antenna described in the claims.

The low noise amplifier 311 amplifies the L1 signal and supplies the signal to the orthogonal detection unit 330. The low noise amplifier 312 amplifies the L5 signal and supplies the L5 signal to the selector 321. The low noise amplifier 313 amplifies the BLE reception signal and supplies the amplified BLE reception signal to the selector 321. The low noise amplifier 314 amplifies the LPWA reception signal and supplies the LPWA reception signal to the selector 321.

The selector 321 selects any one of the L5 signal, the BLE reception signal, and the LPWA reception signal under the control of the processing unit 220 and supplies the selected signal as a selection signal to the orthogonal detection unit 340.

The wireless communication device 200 receives the L5 signal, the BLE reception signal, and the LPWA reception signal in a time division manner. The processing unit 220 controls the selector 321 to select the low noise amplifier 312 during the communication period of the L5 signal, and controls the selector 321 to select the low noise amplifier 313 during the communication period of the BLE signal. Furthermore, the processing unit 220 controls the selector 321 to select the low noise amplifier 314 within the communication period of the LPWA signal.

Here, the communication periods of the L5 signal, the BLE signal, and the LPWA signal need to be set exclusively, but the reception period of the Ll signal can be set to overlap with the communication periods of the L5 signal, the BLE signal, and the LPWA signal.

The orthogonal detection unit 330 performs orthogonal detection on the L1 signal. The orthogonal detection unit 330 generates an in-phase component and an orthogonal component by orthogonal detection, and supplies the in-phase component and the orthogonal component to the ADCs 361 and 362. Note that the orthogonal detection unit 330 is an example of a second orthogonal detection unit.

The orthogonal detection unit 340 performs orthogonal detection on the selection signal from the selector 321. The orthogonal detection unit 340 generates an in-phase component and an orthogonal component by orthogonal detection, and supplies the in-phase component and the orthogonal component to the ADCs 363 and 364. Note that the orthogonal detection unit 340 is an example of a first orthogonal detection unit.

The ADCs 361 and 362 perform analog to digital (AD) conversion on the in-phase component and the orthogonal component, and supply the converted signals to the digital front-end 370. The ADCs 363 and 364 perform AD conversion on the in-phase component and the orthogonal component, and supply the converted signals to the digital front-end 380.

The digital front-end 370 performs various types of digital processing such as image removal on the in-phase component and the orthogonal component after the AD conversion, and supplies the processed signal to the demodulation unit 391. The digital front-end 380 performs various types of digital processing on the in-phase component and the orthogonal component after the AD conversion, and supplies the processed signal to the demodulation units 392, 393, and 394.

The demodulation unit 391 performs demodulation processing on the in-phase component and the orthogonal component of the L1 signal, and supplies the signal to the processing unit 220. The demodulation unit 392 performs demodulation processing on the in-phase component and the orthogonal component of the L5 signal and supplies the signal to the processing unit 220. The demodulation unit 393 performs demodulation processing on the in-phase component and the orthogonal component of the BLE reception signal, and supplies the signal to the processing unit 220. The demodulation unit 393 performs demodulation processing on the in-phase component and the orthogonal component of the LPWA reception signal, and supplies the signal to the processing unit 220.

The modulation unit 395 receives transmission data from the processing unit 220, and generates an LPWA signal by placing the transmission data on a carrier wave by modulation. The LPWA signal to be transmitted is referred to as an LPWA transmission signal. The modulation unit 395 supplies the LPWA transmission signal to the PLL 350. Note that the LPWA transmission signal is an example of a second transmission signal described in the claims, and the modulation unit 395 is an example of a second modulation unit described in the claims.

The modulation unit 396 receives transmission data from the processing unit 220, and generates a BLE signal by placing the transmission data on a carrier wave by modulation. The BLE signal to be transmitted is referred to as a BLE transmission signal. The modulation unit 396 supplies the BLE transmission signal to the PLL 350. Note that the BLE transmission signal is an example of a first transmission signal described in the claims, and the modulation unit 396 is an example of a first modulation unit described in the claims.

The PLL 350 controls a frequency and a phase of a carrier wave by a modulation signal and supplies the frequency and the phase to the selector 322.

The selector 322 selects one of the power amplifiers 315 and 316 according to the control of the processing unit 220, and supplies a signal from the PLL 350 to the power amplifier.

The wireless communication device 200 transmits the LPWA transmission signal and the BLE transmission signal in a time division manner. The processing unit 220 controls the selector 322 to select the power amplifier 315 within the communication period of the LPWA signal, and controls the selector 322 to select the power amplifier 316 within the communication period of the BLE signal.

The power amplifier 315 amplifies the LPWA transmission signal from the selector 322 and supplies the LPWA transmission signal to the transmission antenna 215. The power amplifier 316 amplifies the BLE transmission signal from the selector 322 and supplies the amplified BLE transmission signal to the transmission antenna 216.

The transmission antenna 215 transmits an LPWA transmission signal. The transmission antenna 216 transmits a BLE transmission signal.

The processing unit 220 controls the entire wireless communication device 200. The processing unit 220 sets a communication period of each of the L1 signal, the L5 signal, the BLE signal, and the LPWA signal, and controls a circuit in the communication circuit 300 to transmit and receive each signal. Furthermore, the processing unit 220 performs outdoor positioning using at least one of the L1 signal and the L5 signal, and performs indoor positioning using the BLE signal. Furthermore, the processing unit 220 generates transmission data including position information indicating the current position and the like, and supplies the transmission data to the modulation unit 395. Furthermore, the processing unit 220 generates transmission data including a request, a response, and a beacon signal, and supplies the transmission data to the modulation unit 396. Furthermore, the processing unit 220 transmits and receives data to and from an external device in a wired manner via the I/O interface 230. Each of these functions is realized, for example, by a central processing unit (CPU) executing a predetermined program.

Since outdoor positioning can be performed with only one of the L1 signal and the L5 signal, a circuit from the orthogonal detection unit 340 to the digital front-end 380 is shared by a path of one of the L1 signal and the L5 signal (such as the L5 signal) and a path of the BLE signal. Since the satellite signal and the BLE signal have different reception frequencies, and it is generally difficult to share a transmission antenna and a low noise amplifier, a transmission antenna and a low noise amplifier are provided for each path, and switching is performed by the selector 321. The local frequency, the band of the low-pass filter, and the gain in the orthogonal detection unit 340, and the frequency shift amount, the filter band, and the like in the digital front-end 380 are easily made variable, and are shared in each path. Due to the circuit scale reduction, the cost and the mounting area can be suppressed as compared with the case where the circuit is not shared.

Since the BLE signal and the LPWA signal have different transmission frequencies, and it is generally difficult to share a transmission antenna and a low noise amplifier, switching is performed by the selector 321. On the other hand, both the BLE signal and the LPWA signal can be modulated by the frequency control of the frequency variable oscillator by a method that does not have information in the amplitude direction such as frequency shift keying (FSK), and thus, the modulation unit and the PLL can be easily shared. Although the modulation unit is not shared in the drawing, the modulation unit can be shared by the BLE signal and the LPWA signal.

Due to the circuit sharing, the wireless communication device 200 cannot perform two-frequency reception of the satellite signal and simultaneous reception of the BLE signal, and simultaneous transmission of the BLE signal and the LPWA signal, but can simultaneously receive one frequency of the satellite signal and the BLE signal. Therefore, it is possible to perform seamless continuous positioning regardless of indoor or outdoor.

Furthermore, considering that the transmission time rate of the LPWA signal is considerably suppressed and the transmission frequency of the LPWA signal is generally low, there is almost no disadvantage that the BLE signal and the LPWA signal cannot be transmitted simultaneously and only time-division transmission is performed.

Here, a configuration in which a circuit is not shared by paths of the satellite signal, the BLE signal, and the LPWA signal is assumed as a comparative example.

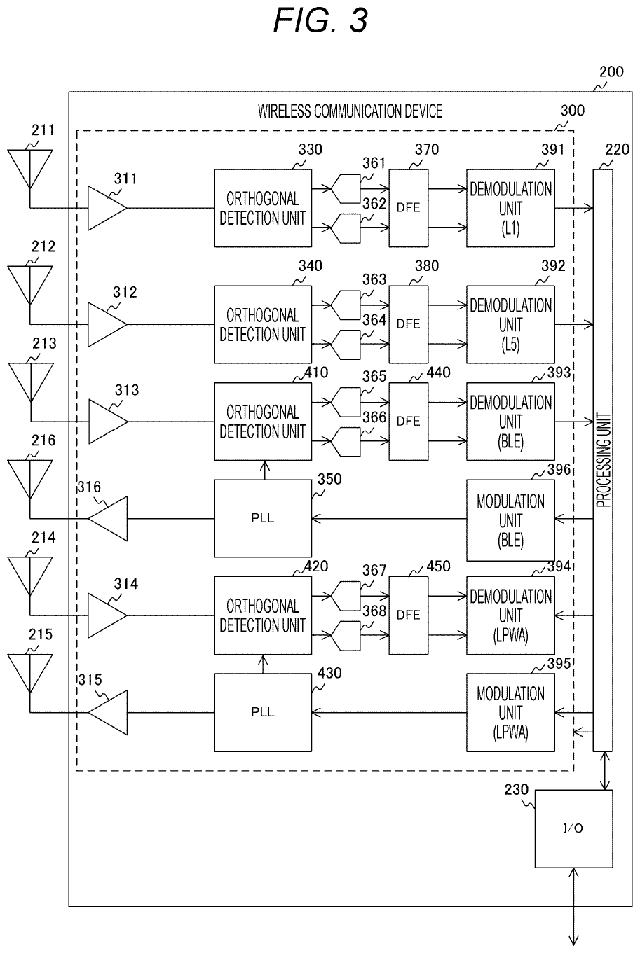

FIG. 3 is a block diagram illustrating a configuration example of a wireless communication device 200 in a comparative example. In this comparative example, the selectors 321 and 322 are reduced, and orthogonal detection units 410 and 420, PLL 430, ADCs 365, 366, 367, and 368, and digital front-ends 440 and 450 are added.

The orthogonal detection unit 410, the ADCs 365 and 366, and the digital front-end 440 are arranged on a path for receiving the BLE signal. The orthogonal detection unit 420, the ADCs 367 and 368, and the digital front-end 450 are arranged on a path for receiving the LPWA signal. The PLL 430 is disposed on a path that transmits the LPWA signal. In the comparative example in which the circuit is not shared, there is an advantage that each wireless function can operate independently as illustrated in the drawing, but there is a possibility that the circuit scale becomes large and the function becomes excessive.

### [Configuration Example of Orthogonal Detection Unit]

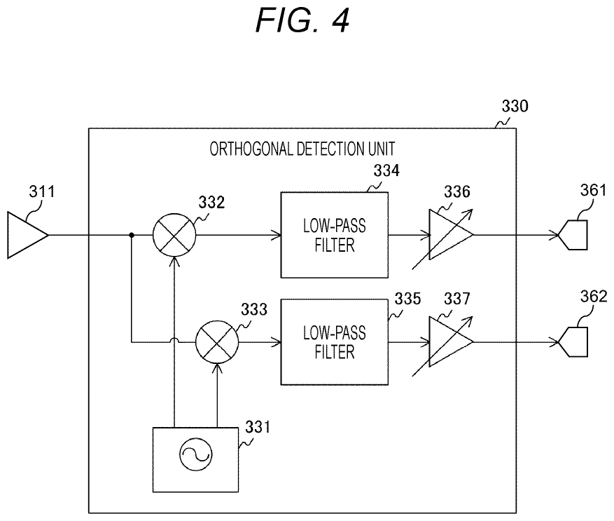

FIG. 4 is a block diagram illustrating a configuration example of the orthogonal detection unit 330 according to the first embodiment of the present technology. The orthogonal detection unit 330 includes a local oscillator 331, mixers 332 and 333, low-pass filters 334 and 335, and variable gain amplifiers 336 and 337.

The local oscillator 331 generates two local signals different in phase by 90 degrees. The frequency of the local signal is controlled by the processing unit 220. The local oscillator 331 supplies one of the pair of local signals to the mixer 332 and supplies the other to the mixer 333.

The mixer 332 mixes the L1 signal from the low noise amplifier 311 and the local signal, and supplies the mixed signal to the low-pass filter 334 as an in-phase component. The mixer 333 mixes the L1 signal and the local signal and supplies the mixed signal to the low-pass filter 335 as an orthogonal component.

The low-pass filter 334 passes a band lower than or equal to a cutoff frequency among in-phase components. The low-pass filter 335 passes a band lower than or equal to a cutoff frequency among orthogonal components. The cutoff frequencies of these filters are controlled by the processing unit 220. Note that a band pass filter can be used instead of the low-pass filter.

The variable gain amplifier 336 amplifies the in-phase component having passed through the low-pass filter 334 with a predetermined gain and supplies the same to the ADC 361. The variable gain amplifier 337 amplifies the orthogonal component having passed through the low-pass filter 335 with a predetermined gain and supplies the same to the ADC 362. The gains of these amplifiers are controlled by the processing unit 220.

Note that the circuit configuration of the orthogonal detection unit 340 is similar to that of the orthogonal detection unit 330.

### [Configuration Example of Digital Front-End]

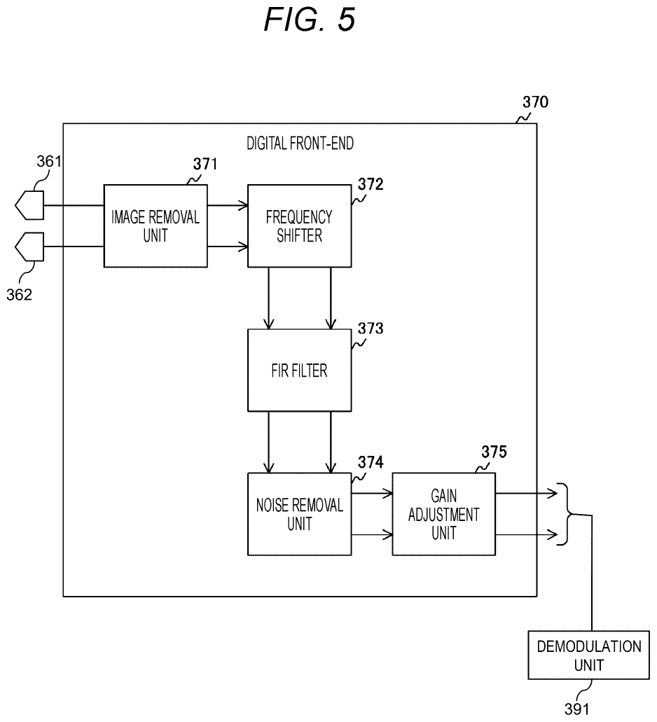

FIG. 5 is a block diagram illustrating a configuration example of the digital front-end 370 according to the first embodiment of the present technology. The digital front-end 370 includes an image removal unit 371, a frequency shifter 372, a finite impulse response (FIR) filter 373, a noise removal unit 374, and a gain adjustment unit 375.

The image removal unit 371 corrects the gain and the phase mismatch of the digital signals (in-phase component and orthogonal component) from the ADCs 361 and 362 to remove the interference of the image frequency, and supplies the signal to the frequency shifter 372.

The frequency shifter 372 shifts the center frequency of the digital signal to a frequency of 0 and supplies the signal to the FIR filter 373. Note that, in a case where the direct conversion system is used, the frequency shifter 372 is unnecessary.

The FIR filter 373 removes a component outside a predetermined band from the digital signal and supplies the signal to the noise removal unit 374.

The noise removal unit 374 removes an interference component in a band from the digital signal by a notch filter or the like and supplies the signal to the gain adjustment unit 375.

The gain adjustment unit 375 amplifies the digital signal with a predetermined gain, adjusts the digital signal to a level optimum for subsequent demodulation, and supplies the digital signal to the demodulation unit 391. The gain is controlled by the processing unit 220.

Note that the configuration of the digital front-end 380 is similar to that of the digital front-end 370.

### [Configuration Example of Processing Unit]

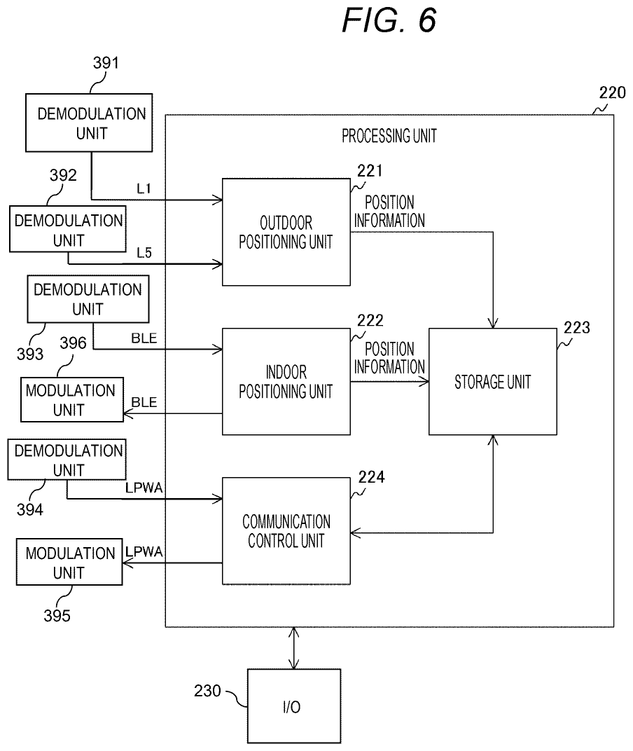

FIG. 6 is a block diagram illustrating a configuration example of the processing unit 220 according to the first embodiment of the present technology. The processing unit 220 includes an outdoor positioning unit 221, an indoor positioning unit 222, a storage unit 223, and a communication control unit 224.

The outdoor positioning unit 221 measures the current position using at least one of the L1 signal and the L5 signal from the demodulation units 391 and 392. However, since one of the L1 signal and the L5 signal (such as the L5 signal) is received in time division manner with the BLE signal and the LPWA signal, the L5 signal or the like cannot be used within the communication periods thereof. The outdoor positioning unit 221 causes the storage unit 223 to hold position information indicating the measured current position.

The indoor positioning unit 222 measures the current position using the BLE reception signal from the demodulation unit 393. The indoor positioning unit 222 searches for a BLE reception signal including a beacon signal, and establishes a link with a beacon terminal or the like when entering an area where a beacon terminal or a locator is present.

Then, the indoor positioning unit 222 controls the communication circuit 300 to transmit and receive a request regarding the positioning method and a response to the request to and from the beacon terminal or the locator. For example, the indoor positioning unit 222 causes a beacon terminal or the like to transmit a BLE transmission signal including a request, and causes the beacon terminal or the like to receive a BLE reception signal including a response. Note that, depending on the protocol, a beacon terminal or the like can transmit a request to the wireless communication device 200, and the wireless communication device 200 can return a response. In the response to the request, for example, a positioning method available to a transmission source of the response, and identification information and position information of the transmission source are described.

The indoor positioning unit 222 determines whether or not indoor positioning is possible on the basis of the beacon signal. In a case where indoor positioning is possible, the indoor positioning unit 222 detects an available indoor positioning method on the basis of the response. In a case where a plurality of indoor positioning methods is available, the indoor positioning unit 222 determines a positioning method to be used and notifies a beacon terminal or the like of the determined positioning method. Note that an external device of the wireless communication device 200 such as a locator or the positioning server 150 can detect and determine the indoor positioning method. In this case, the locator or the like notifies the wireless communication device 200 of the determined positioning method.

In a case where a method for performing positioning on the side of the wireless communication device 200, such as the AoD method, is determined, the indoor positioning unit 222 controls the communication circuit 300 to receive a BLE reception signal including a beacon signal, and measures the current position on the basis of the beacon signal. Then, the indoor positioning unit 222 causes the storage unit 223 to hold position information indicating the current position.

On the other hand, in a case where a method for performing positioning outside the wireless communication device 200, such as the AoA method, is determined, the indoor positioning unit 222 controls the communication circuit 300 to transmit a BLE transmission signal including a beacon signal. In this case, the current position of the wireless communication device 200 is measured by the external positioning server 150. Note that, in the RSSI method, a circuit in the communication circuit 300 is controlled depending on which of the wireless communication device 200 and the positioning server 150 performs positioning.

Furthermore, in a case where indoor positioning is possible, the indoor positioning unit 222 can also transmit and receive a BLE signal including authentication information to and from a beacon terminal or the like prior to the indoor positioning described above. In this case, the beacon terminal or the like authenticates the wireless communication device 200 using the received authentication information and notifies the authentication result, and the wireless communication device 200 authenticates the beacon terminal or the like using the authentication information from the beacon terminal or the locator and notifies the authentication result. Then, when mutual authentication is successful, the communication system 100 performs the indoor positioning described above. By performing indoor positioning when mutual authentication succeeds, it is possible to avoid erroneous positioning due to a spoofing signal by an intentional false locator. Therefore, reliability of the positioning can be improved.

The communication control unit 224 controls the communication circuit 300 to transmit and receive the LPWA signal. For example, the communication control unit 224 reads the position information from the storage unit 223 and causes the communication circuit 300 to transmit the LPWA transmission signal including the position information.

### [Operation Example of Wireless Communication Device]

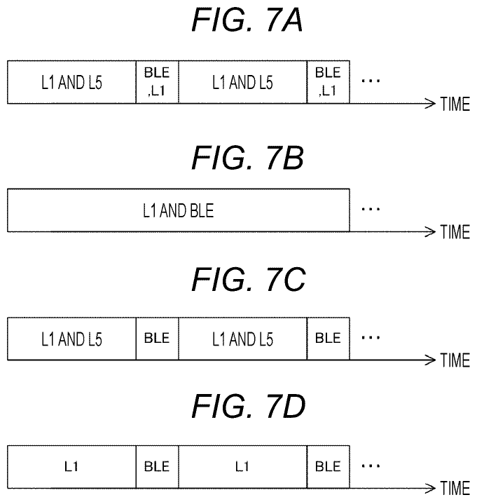

FIG. 7 is a diagram illustrating an example of control of the communication circuit 300 according to the first embodiment of the present technology. For example, as illustrated in a of the drawing, the processing unit 220 controls the communication circuit 300 to alternately repeat a period in which the L1 signal and the L5 signal are simultaneously received and a period in which the BLE signal and the L1 signal are simultaneously received. The processing unit 220 performs outdoor positioning using the L1 signal and the L5 signal in a period in which the L1 signal and the L5 signal are simultaneously received. On the other hand, in a period in which the BLE signal and the L1 signal are simultaneously received, the processing unit 220 executes outdoor positioning using the L1 signal and indoor positioning using the BLE signal in parallel.

Alternatively, as illustrated in b of the drawing, the processing unit 220 can control the communication circuit 300 not to receive the L5 signal but to receive the BLE signal and the L1 signal in parallel. The reception timing and the reception frequency of each of the L1 signal and the BLE signal can be arbitrarily set.

Alternatively, as illustrated in c of the drawing, the processing unit 220 can also control the communication circuit 300 to alternately repeat a period in which the Ll signal and the L5 signal are simultaneously received and a period in which only the BLE signal is received.

Alternatively, as illustrated in d of the drawing, the processing unit 220 can also control the communication circuit 300 to alternately repeat the period of receiving only the L1 signal and the period of receiving only the BLE signal.

In the control of a and b in the drawing, since the L1 signal and the BLE signal can be simultaneously received, it is possible to realize seamless positioning indoors or outdoors. In c and d of the drawing, since the L1 signal, the L5 signal, and the BLE signal are received in a time division manner, there is no need to simultaneously perform indoor positioning and outdoor positioning, and the processing load and power consumption of the wireless communication device 200 can be reduced.

Which of the various types of control illustrated in the drawing is performed is appropriately determined on the basis of the state of the wireless communication device 200 or the setting of the user.

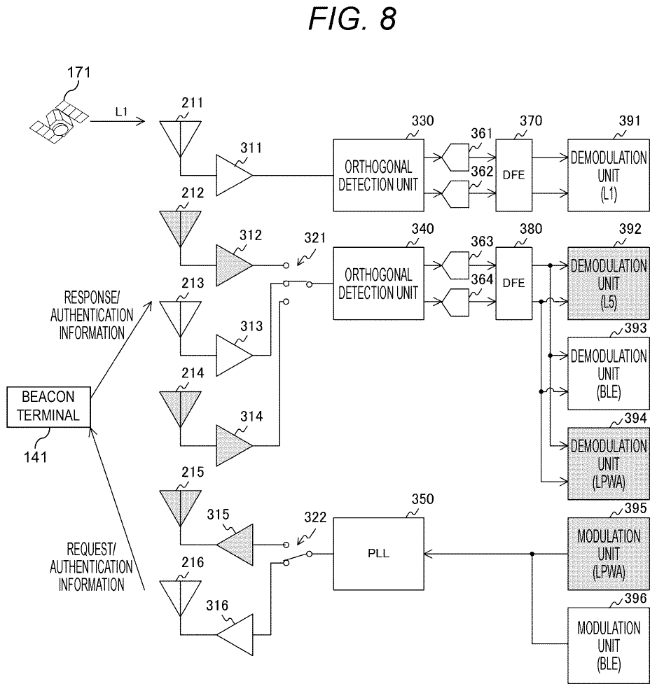

FIG. 8 is a diagram illustrating an example of a state of the communication circuit 300 when a BLE positioning method is detected or authenticated according to the first embodiment of the present technology. The processing unit 220 stops the low noise amplifier 314, the demodulation unit 394, the power amplifier 315, and the modulation unit 395 outside the communication period of the LPWA signal. Furthermore, the processing unit 220 switches the connection destination of the selector 322 to the power amplifier 316. In the drawing, a gray portion indicates a circuit that has stopped due to power cutoff or an enable signal.

Then, the processing unit 220 further stops the low noise amplifier 312 and the demodulation unit 392 within a period in which the L1 signal and the BLE signal are simultaneously received. Furthermore, the processing unit 220 switches the connection destination of the selector 321 to the low noise amplifier 313. During the reception of the L1 signal and the BLE signal, the wireless communication device 200 receives the BLE signal including the beacon signal from the beacon terminal 141 or the like.

The wireless communication device 200 transmits, for example, a BLE signal including a request regarding an available positioning method to the beacon terminal 141 or the like, and receives the BLE signal including a response to the request. Then, the wireless communication device 200 detects an available positioning method on the basis of the response, and determines a method to be used. Furthermore, prior to indoor positioning, the wireless communication device 200 can also transmit and receive a BLE signal including authentication information to and from the beacon terminal 141 or the like.

As illustrated in the drawing, by providing the transmission path of the BLE signal, it is possible to transmit and receive a request and a response related to the positioning method to and from the beacon terminal or the locator. Therefore, various indoor positioning methods such as the AoD method and the AoA method can be used, and the convenience and versatility of the communication system 100 can be improved.

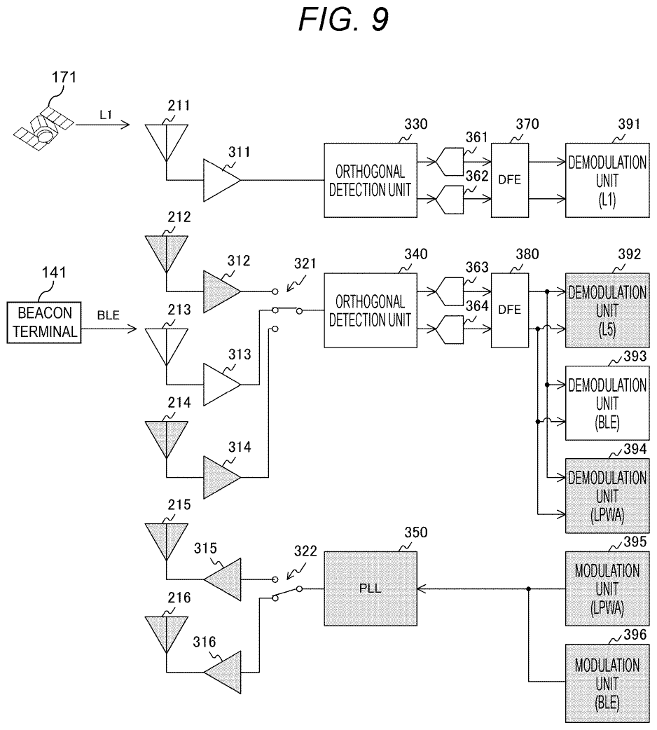

FIG. 9 is a diagram illustrating an example of a state of a communication circuit when positioning is performed using an AoD method according to the first embodiment of the present technology. In FIG. 8 described above, it is assumed that the wireless communication device 200 determines the AoD method and succeeds in mutual authentication. During the positioning by the AoD method, the processing unit 220 further stops the power amplifier 316, the PLL 350, and the modulation unit 396 as illustrated in FIG. 9. In the drawing, a gray portion indicates a circuit that has stopped due to power cutoff or an enable signal.

Note that, in addition to the AoD method, similar control is performed also in a case where the wireless communication device 200 performs measurement by the RSSI method or the like.

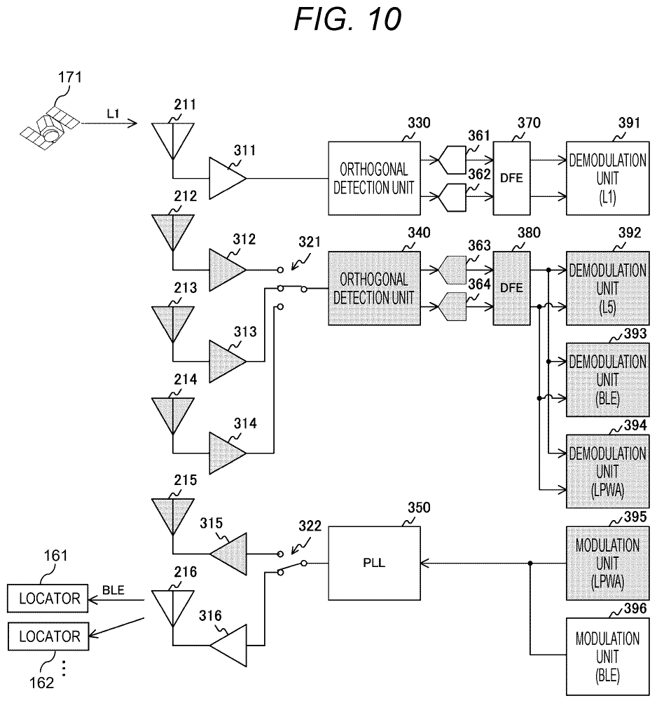

FIG. 10 is a diagram illustrating an example of a state of a communication circuit when positioning is performed using an AoA method according to the first embodiment of the present technology. In FIG. 8 described above, it is assumed that the wireless communication device 200 determines the AoA method and succeeds in mutual authentication. During the positioning by the AoA method, as illustrated in FIG. 10, the processing unit 220 further stops the low noise amplifier 313, the orthogonal detection unit 340, the ADC 363, the ADC 364, the digital front-end 380, and the demodulation unit 393. In the drawing, a gray portion indicates a circuit that has stopped due to power cutoff or an enable signal.

Note that, in addition to the AoA method, similar control is performed also in a case where an external device of the wireless communication device 200 performs measurement by the RSSI method or the like.

As illustrated in FIGS. 8 to 10, the processing unit 220 can reduce power consumption by stopping unnecessary circuits in the communication circuit 300. Furthermore, as illustrated in FIGS. 8 to 10, the wireless communication device 200 can simultaneously receive the satellite signal and the BLE signal independently. Therefore, for example, an integrated positioning result can be obtained by outdoor positioning or outdoor positioning at a place such as a boundary area between indoor and outdoor, such as a window or a place with a thin ceiling or a place with an open ceiling in a building. In the boundary region, the GNSS tends to have a large positioning error due to a decrease in the number of satellites and multipath. However, even if the number of locators is small and the accuracy is poor, if there is a distance measurement/positioning result by the BLE signal, it is possible to improve the accuracy by correcting the positioning result by matching the positioning result with the positioning result by the satellite signal or by performing complement processing for comparing the BLE locator to the GNSS satellite.

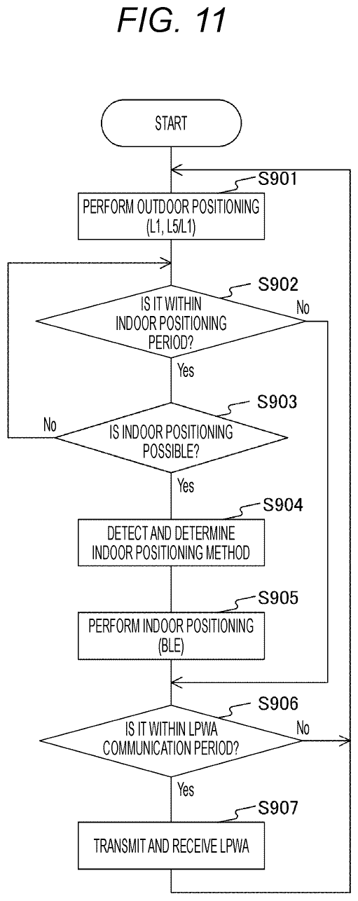

FIG. 11 is a flowchart illustrating an example of operation of the wireless communication device 200 according to the first embodiment of the present technology. This operation is started, for example, when power is supplied to the wireless communication device 200.

The wireless communication device 200 periodically receives the L1 signal and the L5 signal, and performs outdoor positioning using the L1 signal and the L5 signal (step S901). Then, the wireless communication device 200 determines whether or not the current time is within the indoor positioning period (step S902).

In a case where it is within the indoor positioning period (step S902: Yes), the wireless communication device 200 determines whether or not indoor positioning is possible on the basis of the beacon signal (step S903). In a case where the indoor positioning is not possible (step S903: No), the wireless communication device 200 repeats step S902 and the subsequent steps.

In a case where indoor positioning is possible (step S903: Yes), the wireless communication device 200 detects an indoor positioning method that can be used by transmission and reception of a request and a response, and determines either one (step S904). Then, the wireless communication device 200 performs indoor positioning using the BLE signal (step S905).

In a case where the current time is outside the indoor positioning period (step S902: No), or after step S905, the wireless communication device 200 determines whether or not the current time is within the LPWA communication period (step S906).

In a case where the current time is within the LPWA communication period (step S906: Yes), the wireless communication device 200 transmits and receives the LPWA signal (step S907). In a case where the current time is outside the LPWA communication period (step S906: No), or after step S907, the wireless communication device 200 repeats step S901 and the subsequent steps.

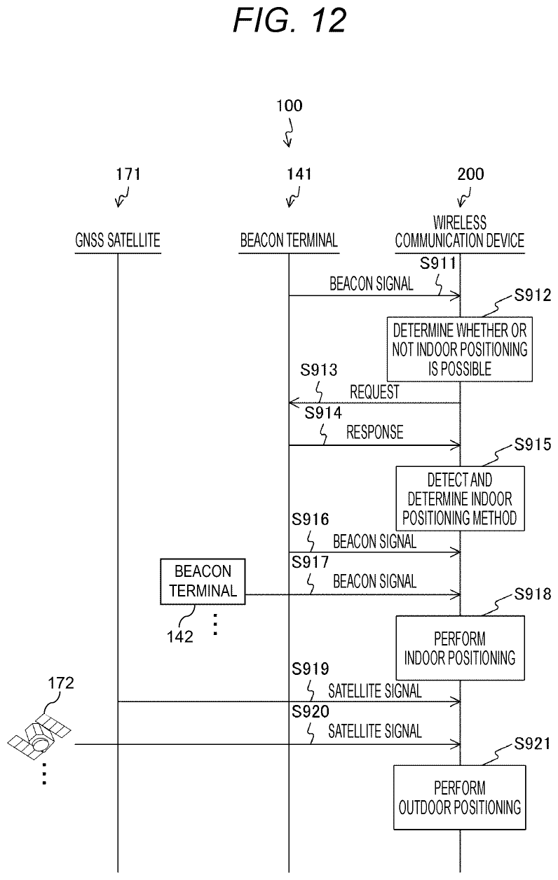

FIG. 12 is a sequence diagram illustrating an example of an operation of the communication system 100 according to the first embodiment of the present technology. It is assumed that the wireless communication device 200 has moved into an area where radio waves from the beacon terminal 141 reach. The wireless communication device 200 receives the beacon signal from the beacon terminal 141 (step S911), and determines whether or not indoor positioning is possible on the basis of the beacon signal (step S912).

In a case where indoor positioning is possible, the wireless communication device 200 transmits a request related to an available positioning method to the beacon terminal 141 or the like (step S913), and receives a response (step S914). The wireless communication device 200 detects the indoor positioning method on the basis of the response, and determines either one (step S915). For example, it is assumed that the AoD method is determined.

The wireless communication device 200 receives beacon signals from a plurality of terminals such as the beacon terminals 141 and 142 (steps S916 and S917), and performs indoor positioning by the AoD method (step S918).

Furthermore, the wireless communication device 200 receives satellite signals from a plurality of GNSS satellites such as the GNSS satellites 171 and 172 (steps S919 and S920), and performs outdoor positioning (step S921). In the drawing, for convenience of description, the wireless communication device 200 performs indoor positioning and outdoor positioning in order, but as described above, these can be performed simultaneously.

As described above, according to the first embodiment of the present technology, since the wireless communication device 200 transmits and receives a request and a response while sharing some circuits, it is possible to use various positioning methods while reducing cost and circuit scale. Therefore, it is possible to improve convenience of the device.

### 2. Second Embodiment

In the first embodiment described above, the wireless communication device 200 receives both of the two frequencies (the L1 signal, the L5 signal, and the like), but with this configuration, it is difficult to further reduce the cost and the circuit scale. A wireless communication device 200 in a second embodiment is different from that in the first embodiment in that only one frequency is received.

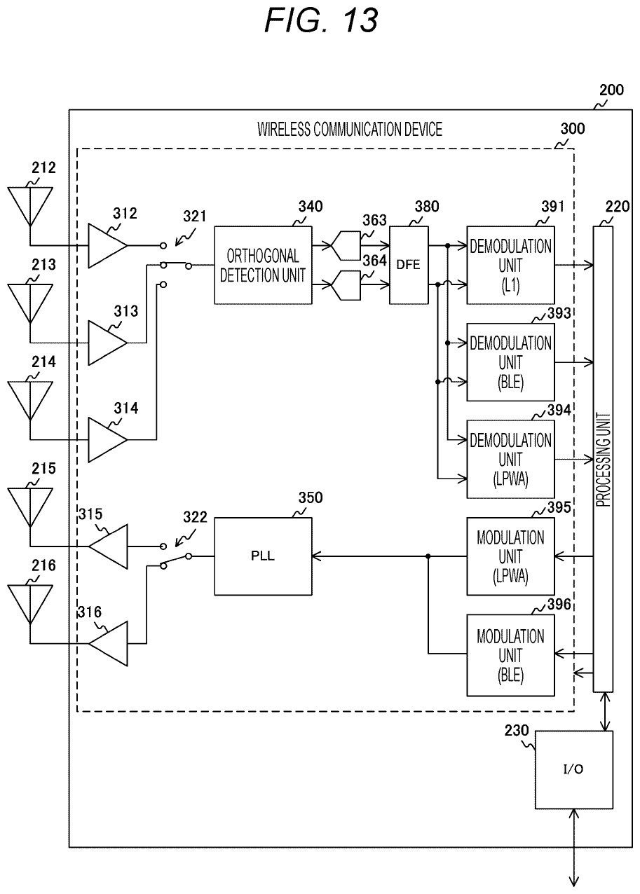

FIG. 13 is a block diagram illustrating a configuration example of the wireless communication device 200 according to the second embodiment of the present technology. The wireless communication device 200 of the second embodiment is different from that of the first embodiment in that one reception path of two frequencies is reduced. Specifically, the reception antenna 211, the low noise amplifier 311, the orthogonal detection unit 330, the ADC 361, the ADC 362, the digital front-end 370, and the demodulation unit 392 are reduced.

In the configuration illustrated in the drawing, the wireless communication device 200 receives the satellite signal, the BLE signal, and the LPWA signal in a time division manner.

As described above, according to the second embodiment of the present technology, since the reception path of one of the two frequencies is reduced, the cost and circuit scale of the wireless communication device 200 can be reduced.

### 3. Third Embodiment

In the first embodiment described above, the LPWA signal is transmitted and received, but with this configuration, it is difficult to further reduce the cost and the circuit scale. A wireless communication device 200 according to a third embodiment is different from that in the first embodiment in not transmitting and receiving an LPWA signal.

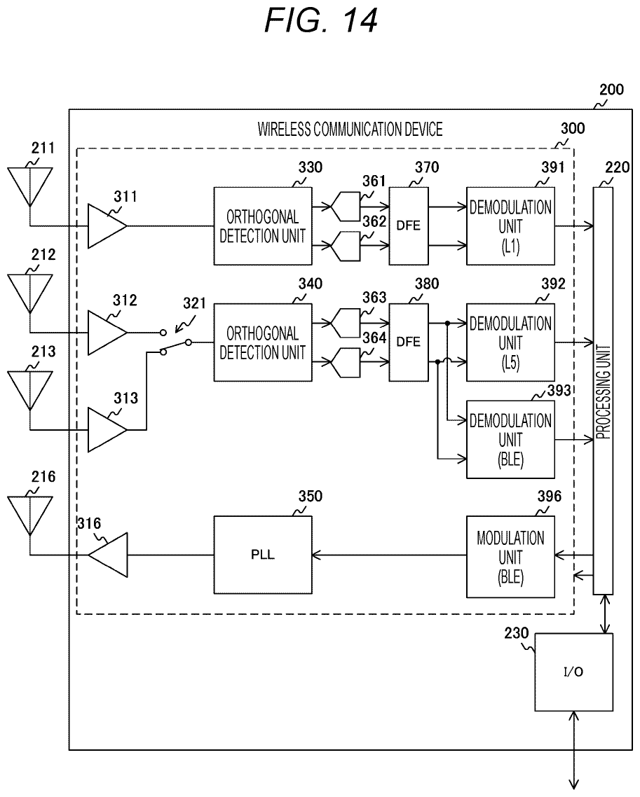

FIG. 14 is a block diagram illustrating a configuration example of the wireless communication device 200 according to the third embodiment of the present technology. The wireless communication device 200 of the third embodiment is different from that of the first embodiment in that transmission/reception path of LPWA signals is reduced. Specifically, the reception antenna 214, the low noise amplifier 314, the demodulation unit 394, the transmission antenna 215, the power amplifier 315, the selector 322, and the modulation unit 395 are reduced.

Note that the third embodiment can be applied to the second embodiment. In this case, both the reception path of one of the two frequencies and the transmission/reception path of the LPWA signal are reduced.

As described above, according to the third embodiment of the present technology, since the transmission/reception path of the LPWA signal is reduced, the cost and circuit scale of the wireless communication device 200 can be reduced.

### 4. Application Examples

The technology according to the present disclosure can be applied to a technology called Internet of things (IOT), which is a so-called “Internet of things”. IT is a mechanism in which IoT devices 9100 that are “things” are connected to another IoT device 9003, the Internet, a cloud 9005, and the like, and mutually control by exchanging information. IoT can be used in various industries such as agriculture, home, automobile, manufacturing, distribution, and energy.

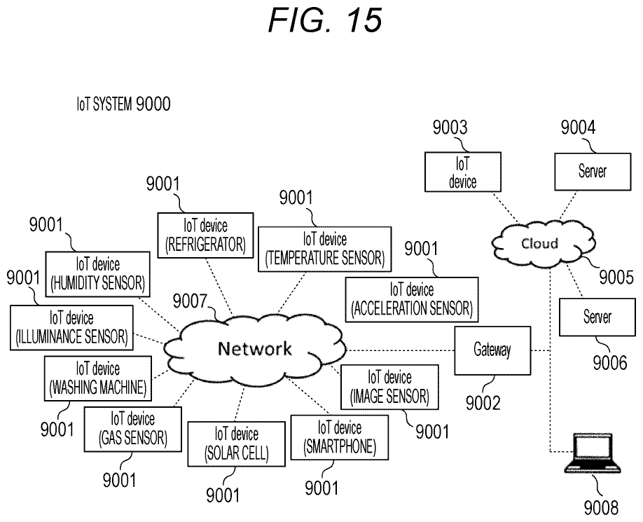

FIG. 15 is a diagram illustrating an example of a schematic configuration of an IoT system 9000 to which the technology according to an embodiment of the present disclosure is applicable.

The IOT devices 9001 include a variety of sensors such as temperature, humidity, illuminance, acceleration, distance, image, gas, and human sensors. Further, the IoT devices 9001 may additionally include terminals such as a smartphone, a mobile phone, a wearable terminal, and a gaming device. The IoT devices 9001 are powered, for example, by an alternating current (AC) power supply, a direct current (DC) power supply, a battery, a non-contact power supply, energy harvesting or the like. The IoT devices 9001 are capable, for example, of wired, wireless, and short-range wireless communication. Communication schemes suitably used are third-generation (3G)/LTE (registered trademark), wireless fidelity (Wi-Fi) (registered trademark), institute of electrical and electronic engineers (IEEE) 802.15.4, Bluetooth (registered trademark), Zigbee (registered trademark), and Z-Wave. The IoT devices 9001 may switch between the plurality of these communication sections to achieve communication.

The IoT devices 9001 may form one-to-one, star, tree, and mesh networks. The IoT devices 9001 may connect to the external cloud 9005 directly or via a gateway 9002. An address is assigned to each of the IoT devices 9001, for example, by internet protocol version (IPv) 4, IPV6, or IPV6 over low power wireless personal area networks (6LowPAN). Data collected from the IoT devices 9001 is sent to the other IoT device 9003, a server 9004, the cloud 9005, and so on. The timings and frequency for sending data from the Iof devices 9001 may be suitably adjusted for transmission of data in a compressed form. Such data may be used in an ‘as-is’ manner or analyzed by a computer 9008 by various sections such as statistical analysis, machine learning, data mining, cluster analysis, discriminant analysis, combinational analysis, and chronological analysis. Such use of data enables provision of numerous services including control, warning, monitoring, visualization, automation, and optimization.

The technology according to an embodiment of the present disclosure is also applicable to home-related devices and services. The IoT devices 9001 in homes include washing machine, drying machine, dryer, microwave oven, dish washing machine, refrigerator, oven, electric rice cooker, cooking appliances, gas appliances, fire alarm, thermostat, air-conditioner, television (TV) set, recorder, audio appliances, lighting appliances, electric water heater, hot water dispenser, vacuum cleaner, electric fan, air purifier, security camera, lock, door-shutter opener/closer, sprinkler, toilet, thermometer, weighing scale, sphygmomanometer and the like. Further, the IoT devices 9001 may include solar cell, fuel cell, storage battery, gas meter, electric power meter, and distribution panel.

A low power consumption communication scheme is desirable as a communication scheme for the IoT devices 9001 in homes. Further, the IoT devices 9001 may communicate by Wi-Fi indoors and by 3G/LTE (registered trademark) outdoors. An external server 9006 designed to control IoT devices may be provided on the cloud 9005 to control the IoT devices 9001. The IoT devices 9001 send data including statuses of home appliances, temperature, humidity, power consumption, and presence or absence of humans and animals indoors and outdoors. Data sent from the home appliances is accumulated in the external server 9006 via the cloud 9005. New services are made available based on such data. The IoT devices 9001 designed as described above can be controlled by voice using voice recognition technologies.

In addition, direct transmission of information from the home appliances to the TV set permits visualization of the statuses of the home appliances. Further, determination of whether or not the resident is at home and transmission of data to air-conditioners and lighting appliances by various sensors makes it possible to turn the power thereof on and off. Still further, advertisements can be shown on the displays provided to various home appliances via the Internet.

An example of the Iof system 9000 to which the technology according to the present disclosure can be applied has been described above. The technology according to the present disclosure can be suitably applied to the IoT devices 9001 among the configurations described above. Specifically, the wireless communication device 200 in FIG. 1 can be applied to the IoT devices 9001. By applying the technology according to the present disclosure to the IoT device 9001, it is possible to improve convenience and versatility while reducing the cost and circuit scale of the device.

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology.

Furthermore, the processing procedures described in the above-described embodiment may be considered as a method including a series of procedures and may be considered as a program for allowing a computer to execute the series of procedures and a recording medium which stores the program. As this recording medium, for example, a compact disc (CD), a MiniDisc (MD), a digital versatile disc (DVD), a memory card, a Blu-ray (registered trademark) disc, and the like can be used.

Note that advantageous effects described in the present description are merely examples and are not limited, and other advantageous effects may be provided.

Note that the present technology may also have the following configurations.

(1) A wireless communication device including: a first transmission antenna that transmits a first transmission signal including one of a request related to a positioning method and a response to the request;
a first reception antenna that receives a first satellite signal;
a second reception antenna that receives a first reception signal including either another of the request and the response or a beacon signal;
a selector that selects one of the first satellite signal and the first reception signal and supplies the selected signal as a selection signal;
a first orthogonal detection unit that performs orthogonal detection on the selection signal; and
a processing unit that measures a current position on the basis of either the first satellite signal or the beacon signal.

(2) The wireless communication device according to (1), in which
both the first transmission signal and the first reception signal are signals conforming to a Bluetooth standard.

(3) The wireless communication device according to (1) or (2), in which
the positioning method includes at least one of an angle of arrival (AoA) method and an angle of departure (AoD) method.

(4) The wireless communication device according to (3), further including:
a first modulation unit that generates the first transmission signal, in which
the processing unit determines a positioning method on the basis of the response, stops the first modulation unit within a measurement period of a current position in a case where the AoD method is determined, and stops the first orthogonal detection unit within a measurement period of the current position in a case where the AoA method is determined.

(5) The wireless communication device according to any one of (1) to (4), further including:
a third reception antenna that receives a second satellite signal having a different frequency band from the first satellite signal; and
a second orthogonal detection unit that performs orthogonal detection on the second satellite signal, in which
the processing unit includes:
an outdoor positioning unit that measures a current position on the basis of at least one of the first and second Satellite signals; and
an indoor positioning unit that measures a current position on the basis of the first reception signal.

(6) The wireless communication device according to any one of (1) to (5), further including:
a second transmission antenna that transmits a second transmission signal having a different communication standard from the first transmission signal;
a fourth reception antenna that receives a second reception signal having a different communication standard from the first reception signal; and
a second modulation unit that generates the second transmission signal, in which
the selector selects one of the first satellite signal, the first reception signal, and the second reception signal.

(7) A method for controlling a wireless communication device, the method including:
a first transmission procedure that transmits a first transmission signal including one of a request related to a positioning method and a response to the request;
a first reception procedure that receives a first satellite signal;
a second reception procedure that receives a first reception signal including either another of the request and the response or a beacon signal;
a selection procedure that selects one of the first satellite signal and the first reception signal and supplies the selected signal as a selection signal;
a first orthogonal detection procedure that performs orthogonal detection on the selection signal; and
a processing procedure that measures a current position on the basis of either the first satellite signal or the beacon signal.

### REFERENCE SIGNS LIST

100 Communication system
110 Application server
120 Network
130 LPWA base station
141, 142 Beacon terminal
150 Positioning server
161, 162 Locator
171, 172 GNSS satellite
200 Wireless communication device
211 to 214 Transmission antenna
215, 216 Reception antenna
220 Processing unit
221 Outdoor positioning unit
222 Indoor positioning unit
223 Storage unit
224 Communication control unit
230 I/O interface
300 Communication circuit
311 to 314 Low noise amplifier
315, 316 Power amplifier
321, 322 Selector
330, 340, 410, 420 Orthogonal detection unit
331 Local oscillator
332, 333 Mixer
334, 335 Low-pass filter
336, 337 Variable gain amplifier
350, 430 PLL
361 to 368 ADC
370, 380, 440, 450 Digital front-end
371 Image removal unit
372 Frequency shifter
373 FIR filter
374 Noise removal unit
375 Gain adjustment unit
391 to 394 Demodulation unit
395, 396 Modulation unit
9001 IoT device

What is claimed is:

1. A wireless communication device comprising:
a first transmission antenna that transmits a first transmission signal including one of a request related to a positioning method and a response to the request;
a first reception antenna that receives a first satellite signal;
a second reception antenna that receives a first reception signal including either another of the request and the response or a beacon signal;
a selector that selects one of the first satellite signal and the first reception signal and supplies the selected signal as a selection signal;
a first orthogonal detection unit that performs orthogonal detection on the selection signal; and
a processing unit that measures a current position on a basis of either the first satellite signal or the beacon signal.

2. The wireless communication device according to claim 1, wherein
both the first transmission signal and the first reception signal are signals conforming to a Bluetooth standard.

3. The wireless communication device according to claim 1, wherein
the positioning method includes at least one of an angle of arrival (AoA) method and an angle of departure (AoD) method.

4. The wireless communication device according to claim 3, further comprising:
a first modulation unit that generates the first transmission signal, wherein
the processing unit determines a positioning method on a basis of the response, stops the first modulation unit within a measurement period of a current position in a case where the AoD method is determined, and stops the first orthogonal detection unit within a measurement period of the current position in a case where the AoA method is determined.

5. The wireless communication device according to claim 1, further comprising:
a third reception antenna that receives a second satellite signal having a different frequency band from the first satellite signal; and
a second orthogonal detection unit that performs orthogonal detection on the second satellite signal, wherein
the processing unit includes:
an outdoor positioning unit that measures a current position on a basis of at least one of the first and second satellite signals; and
an indoor positioning unit that measures a current position on a basis of the first reception signal.

6. The wireless communication device according to claim 1, further comprising:
a second transmission antenna that transmits a second transmission signal having a different communication standard from the first transmission signal;
a fourth reception antenna that receives a second reception signal having a different communication standard from the first reception signal; and
a second modulation unit that generates the second transmission signal, wherein
the selector selects one of the first satellite signal, the first reception signal, and the second reception signal.

7. A method for controlling a wireless communication device, the method comprising:
a first transmission procedure that transmits a first transmission signal including one of a request related to a positioning method and a response to the request;
a first reception procedure that receives a first satellite signal;
a second reception procedure that receives a first reception signal including either another of the request and the response or a beacon signal;
a selection procedure that selects one of the first satellite signal and the first reception signal and supplies the selected signal as a selection signal;
a first orthogonal detection procedure that performs orthogonal detection on the selection signal; and
a processing procedure that measures a current position on a basis of either the first satellite signal or the beacon signal.
